(19) United States
(12) Patent Application Publication
(10) Pub. No.: US 2018/0237061 A1
(43) Pub. Date: Aug. 23, 2018

(54) POWER STEERING ASSEMBLY COMPRISING STEERING TORQUE OVERLAY

(71) Applicant: Knorr-Bremse Steeringsystem GmbH, Wülftrath (DE)

(72) Inventors: Sven KIRSCHBAUM, Mettmann (DE); Ulf LOBE, Wuppertal (DE)

(21) Appl. No.: 15/752,593

(22) PCT Filed: Jul. 26, 2016
(86) PCT No.: PCT/EP2016/067822

§ 371 Date: Feb. 14, 2018

(30) Foreign Application Priority Data
Aug. 14, 2015 (DE) 10 2015 113 461.6

(51) Int. Cl. B62D 5/083; F16H 1/28

(52) U.S. Cl. CPC B62D 5/0835; F16H 1/28

(57) ABSTRACT

The invention relates to a power steering assembly for a hydraulic power steering system of motor vehicles, comprising at least one hydraulic servo valve with a control member (3) for controlling the steering assistance in accordance with a relative rotation of an input shaft with respect to an output shaft (2), and at least one actuator (9) for the relative adjustment of the control member (3) with respect to the input shaft or output shaft (2) in order to influence the steering assistance characteristic. Further, the power steering assembly comprises a summation gearing having a first rotatable drive member (4) that is in operative engagement with the control member (3), and a second rotatable drive member (5) that is in operative engagement with an output element (8) of the actuator (9), and an output member (6). The summation gearing superposes a rotation of the first drive member (4) with a rotation of the second drive member (5) and drives, via the output member (6), an epicyclic gearing with at least one planetary gear (11), which is in operative engagement together with both the input shaft or output shaft (2) and with the control member (3) and can be rotated both about a planetary axis (14) fixed with respect to the frame and about its own axis of rotation (12) orbiting about the planetary axis (14), in such a way that a rotation of the first drive member (4) causes a rotation of the own axis of rotation (12) of the planetary gear (11) orbiting about the planetary axis (14) in such a way that no rotation of the planetary gear (11) about its own axis of rotation (12) occurs as a consequence, but a rotation of the second drive member (5) causes a rotation of the planetary gear (11) about its own axis of rotation (12), wherein the rotation of the planetary gear (11) about its own axis of rotation (12) causes a relative rotation of the input shaft or output shaft (2) with respect to the control member (3).

The present invention relates to a power steering assembly for a power steering system, in particular for a hydraulic power steering system, of motor vehicles according to the preamble of claim 1.

Among other things, power steering assemblies for hydraulic power steering systems of vehicles comprise servo valves also known as rotary servo valves. They control the hydraulic pressure and thus the steering assistance in accordance with the steering torque applied by the driver. Most frequently, rotary servo valves are used in which an input shaft connected via a steering column with a steering wheel rotates relative to a valve portion (also referred to as control member, valve sleeve or sleeve), which is connected to the output shaft and, in rack-and-pinion steering systems, with a steering pinion (also referred to as pinion). A torque-dependent adjustment of the control member of the servo valve, and therefore torque-dependent valve and thus steering power assistance characteristics, is realized through a torsion system between the input shaft and the control member.

In order to realize various further functions of a torque adjuster, for example a lane departure assistant, over- or understeering assistant, tactile feedback, variable steering assistance, for instance dependent on the vehicle speed or load, city mode, parking pilot, steering torque superposition etc., influencing the steering power assistance characteristics of the servo valve independently of the applied torque on the input shaft is known.

DE 10 2009 029 532 A1, for example, discloses a power steering assembly for a hydraulic power steering system of motor vehicles with two planetary gearings, wherein the first planetary gearing is disposed around the control member and the second is disposed around the output shaft or steering pinion. In this case, the sun gear of the first planetary gearing is firmly connected to the control member and the sun gear of the second planetary gearing is firmly connected to the output shaft. The ring gears of the two planetary gearings are mounted so as to be rotatable independently of each other. The connection of the two planetary gearings is realized by means of a joint planet carrier which carries the planet gears of the two gearings on common shafts. The planet gears can rotate on the shafts independently. The two ring gears have two different external toothings into which a two-stage pinion engages. A rotation of this pinion causes a rotation of both ring gears, wherein a difference angle is produced between them due to the different external toothings of the ring gears. This difference angle is transmitted slightly amplified to the control member and the output shaft by the gear ratio of the planetary gearings.

Against this background, the present invention is based on the object of providing a simplified power steering assembly for a hydraulic power steering system of motor vehicles with a steering torque superposition, which, in particular, has a smaller and lighter build. Independently of a steering input quantity set by a driver of the motor vehicle, a steering superposition quantity is to be superposable through an actuator without the actuator having to follow the steering movements of the driver.

This object is achieved with a power steering assembly having the features of claim 1. Other particularly advantageous embodiments of the invention are disclosed by the dependent claims.

It must be noted that the features cited individually in the claims can be combined with each other in any technologically meaningful manner and represent other embodiments of the invention. The description, in particular in connection with the FIGURES, additionally characterizes and specifies the invention.

According to the invention, a power steering assembly for a hydraulic power steering system of motor vehicles comprises at least one hydraulic servo valve and at least one actuator.

The hydraulic servo valve substantially comprises an input shaft, an output shaft and a control member. The control member, also referred to as a control element, serves for controlling the steering assistance in accordance with the relative rotation of the input shaft relative to the output shaft. In this description, the term “control member” is always supposed to mean the cooperation of substantially two functional units, i.e. a control sleeve on the one hand and the control edges on the input shaft side, on the other.

The at least one actuator of the power steering assembly according to the invention serves for the relative adjustment of the control member relative to the input shaft or the output shaft. This makes it possible to influence the steering assistance characteristics. It should be understood that in this case, the rotary movement caused by a driver on the input shaft is always transmitted to the output shaft independently of the activity of the actuator. Even in the case in which, for example, the actuator fails, the normal function of the power steering assembly is ensured.

Further, the power steering assembly according to the invention comprises a summation gearing and an epicyclic gearing.

The summation gearing has a first rotatable drive member that is in operative engagement with the control member, and a second rotatable drive member that is in operative engagement with an output element of the actuator, and an output member. The summation gearing is characterized in that it superposes a rotation of the first drive member with a rotation of the second drive member and drives the epicyclic gearing via the output member.

The epicyclic gearing comprises at least one planetary gear, which is in operative engagement together with both the input shaft or output shaft and with the control member. The term “input shaft or output shaft” used herein constitutes an alternative which is to be understood as a reference to either the input shaft of the servo valve or to the output shaft of the servo valve. In the above case, the planetary gear, accordingly, is in operative engagement either with the input shaft and the control member or with the output shaft and the control member. The planetary gear is rotatable both about a planetary axis of the epicyclic gearing fixed with respect to the frame and about its own axis of rotation orbiting about the planetary axis fixed with respect to the frame. In this case, fixed with respect to the frame means that the position of the planetary axis relative to the power steering assembly does not change during the operation of the epicyclic gearing.

According to the invention, the output member of the summation gearing drives the epicyclic gearing in such a way that a rotation of the first drive member of the summation gearing causes a rotation of the own axis of rotation of the planetary gear orbiting about the planetary axis fixed with respect to the frame in such a way that no rotation of the planetary gear about its own axis of rotation occurs as a consequence. Accordingly, the planetary gear in this case orbits only around the planetary axis fixed with respect to the frame of the epicyclic gearing, but does not rotate about its own axis of rotation in the process. In other words, the planetary gear's own axis of rotation must rotate about the planetary axis fixed with respect to the frame with the same angular velocity as the input shaft or output shaft rotate, with which the planetary gear is in operative engagement. Since the planetary gear is in operative engagement both with the input shaft or output shaft and the control member, this movement of the planetary gear causes a rotation of the input shaft or output shaft to be transmitted to the control member 1:1, i.e. without transformation. Accordingly, the control member follows the rotation of the input shaft or output shaft, as this is also the case in a conventional power steering assembly without a steering torque superposition.

In contrast, a rotation of the second drive member of the summation gearing causes a rotation of the planetary gear about its own axis of rotation. According to the invention, the rotation of the planetary gear about its own axis of rotation causes a relative rotation of the input shaft or output shaft relative to the control member, whereby a difference angle between the input shaft or output shaft and the control member can be set for a steering torque superposition. Since the second drive member of the summation gearing is in operative engagement with the output element of the actuator, and the rotary movement of the second drive member, independently of the rotary movement of the first drive member, becomes superposable therewith, the steering torque superposition is therefore possible through the actuator independently of a steering movement of a driver of the motor vehicle initiated via the input shaft of the servo valve. Accordingly, the actuator does not have to follow the steering movement of the driver, which constitutes a considerable simplification of the operation of the power steering assembly. Furthermore, the epicyclic gearing can be designed considerably more simply, smaller and so as to require fewer components than the summation gearing, so that the power steering assembly, as a whole, has a smaller and lighter build. Since only the epicyclic gearing directly causes the setting of the difference angle between the input shaft or output shaft and the control member, the summation gearing may furthermore be configured with s significantly lower toothing quality than the epicyclic gearing. The clearances present in the summation gearing between the individual components only have a marginal effect on the gear ratio between the input shaft and output shaft and the control member as it is defined by the epicyclic gearing.

An advantageous embodiment of the invention provides that the epicyclic gearing is concentrically disposed around the input shaft or output shaft and the control member. Further, the epicyclic gearing has a first sun gear non-rotatably connected to the control member, and a second sun gear non-rotatably connected to the input shaft or output shaft. Here, the planetary gear is in rotational engagement with the two sun gears. Rotational engagement in the sense of the invention is understood to be both a friction-fit as well as a positive-fit type of transmission of a rotary movement, in this case between the planetary gear and the two sun gears. The concentric arrangement of the epicyclic gearing around the input shaft or output shaft and the control member as well as the rotational engagement between the epicyclic gearing and the input shaft or output shaft and the control member facilitate a compact and space-saving construction of the power steering assembly according to the invention.

A relative rotation of the two sun gears relative to one another due to the rotation of the planetary gear can be easily realized by, for example, different outer diameters of the sun gears, both of which roll on the common planetary gear.

Preferably, the planetary gear is a cogwheel and the two sun gears of the epicyclic gearing have different external toothings. In order to obtain a clearance-free or almost clearance-free transmission of the gear ratio between the two sun gears, only the planetary gear and the two sun gears of the epicyclic gearing must be designed with a high toothing quality. In this case, the summation gearing can be configured with toothing parts of a lower quality because the clearances produced there have only a marginal effect on the relative rotation of the input shaft or output shaft relative to the control member. Furthermore, a possible clearance between the planetary gear and the two sun gears can be eliminated in a simple manner by bringing the planetary gear close up to the sun gears.

According to another preferred embodiment of the invention, the at least one planetary gear of the epicyclic gearing is rotatably retained by a planetary gear carrier which is rotatable about the planetary axis of the epicyclic gearing. In this case, the planetary gear carrier is in rotational engagement with the output member of the summation gearing. In this manner, the drive of the epicyclic gearing by means of the summation gearing provided by the invention can be realized with as few components as possible, which results in further space being saved and an even lighter and more compact build of the power steering assembly.

Another advantageous embodiment of the invention provides that a secondary drive gear, which is in rotational engagement with the first drive member of the summation gearing, is non-rotatably connected to the control member.

According to another advantageous embodiment of the invention, the summation gearing is a planetary gearing with a sun gear, one or several planet gears rotatably retained by a planet carrier, and a ring gear. Here, the ring gear forms the first drive member of the summation gearing, the sun gear forms the second drive member of the summation gearing, and the planet carrier forms the output member of the summation gearing.

Particularly preferably, the planetary gearing is a toothed gearing, wherein the ring gear has both an internal toothing, which is in rotational engagement with the one or several planet gears, and an external toothing, which is in rotational engagement with an external toothing of the secondary drive gear connected to the control member.

Another preferred embodiment of the invention provides that the actuator is an electric drive motor and the output element is an output shaft, which is driven by the drive motor and is non-rotatably connected to the second drive member of the summation gearing. In this manner, the rotary movement of the drive motor can be directly used for the rotary drive of the second drive member in the summation gearing without further conversion.

According to a particularly preferred advantageous embodiment of the invention, the summation gearing is disposed eccentrically with respect to the input shaft or output shaft and the control member. In particular, advantages with regard to the construction space of the power steering assembly according to the invention can thus be obtained.

Other features and advantages of the invention become apparent from the following description of an exemplary embodiment of the invention, which is to be understood not to be limiting and which will be explained below with reference to the FIGURES. In this drawing, the FIGURES schematically show:

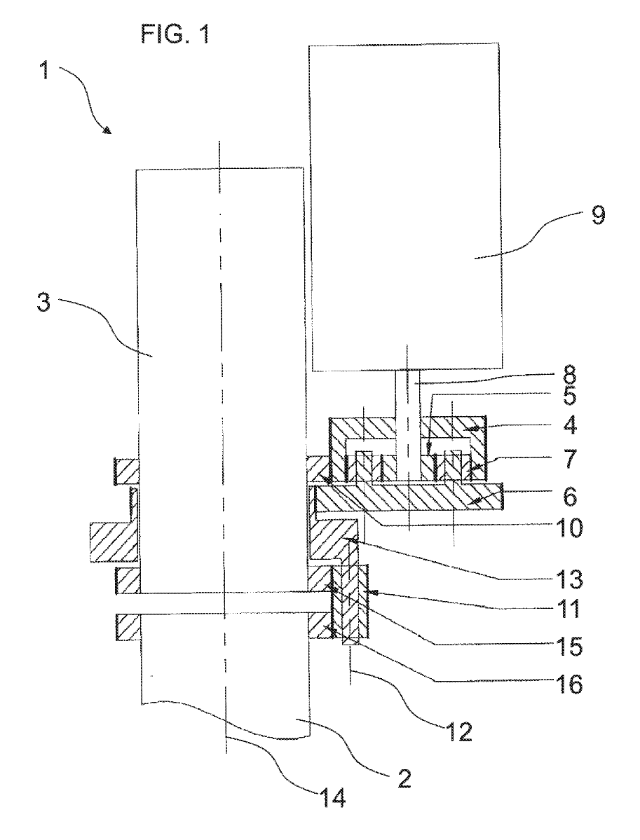

FIG. 1: a lateral sectional view of an exemplary embodiment of a power steering assembly according to the invention.

FIG. 1 constitutes a lateral sectional view of an exemplary embodiment of a power steering assembly 1 according to the invention.

The power steering assembly 1 substantially comprises a hydraulic servo valve, an actuator, a summation gearing and an epicyclic gearing.

The servo valve substantially comprises an input shaft (not shown), an output shaft 2 and a control member 3. The input shaft is connected to a steering wheel of a motor vehicle via a steering column, which is not shown. In turn, the output shaft 2 is indirectly connected to wheels of the motor vehicle that are to be rotated, which are not shown. In a known manner, the input shaft is connected to the output shaft 2 via a torsion bar (also not shown), wherein the torsion bar on its one end is non-rotatably connected to the input shaft and on its other end non-rotatably connected to the output shaft 2. Accordingly, the torsion bar establishes a coupling between the input shaft and the output shaft 2, wherein it permits a relative rotation between them. Moreover, the control member 3 is disposed concentrically with and around the input shaft. The control member 3 is mounted so as to be rotatable and/or displaceable relative to the input shaft.

The function and mode of action of the power steering assembly 1 described up to this point are generally known from the prior art.

As is also apparent from FIG. 1, the summation gearing comprises a first drive member 4, a second drive member 5 and an output member 6. The summation gearing of the illustrated power steering assembly 1 is configured as a planetary gear unit in which a ring gear forms the first drive member 4, a sun gear forms the second drive member 5 and a planet carrier forms the output member 6. The planet carrier 6 carries several planet gears 7, which are rotatably mounted on corresponding shafts and in rotational engagement with an internal toothing of the ring gear 4 and a toothing of the sun gear 5 in a known manner.

The second drive member 5 of the summation gearing is non-rotatably connected to an output element 8 of the actuator 9. In the exemplary embodiment of the power steering assembly 1 shown in FIG. 1, the actuator 9 is an electric drive motor with a driven output shaft forming the output element 8.

Furthermore, it can be seen in FIG. 1 that a secondary drive gear 10 is non-rotatably connected to the control member 3. Via the secondary drive gear 10, the control member 3 is in operative engagement with the first drive member 4, in particular with the ring gear 4, of the summation gearing. For this purpose, the ring gear 4 also has an external toothing via which the secondary drive gear 10, which is configured as a cogwheel, is in rotational engagement.

As is apparent from FIG. 1, the summation gearing of the power steering assembly 1 is disposed eccentrically with respect to the output shaft 2 and the control member 3.

Furthermore, the epicyclic gearing driven by the summation gearing can be recognized in FIG. 1. The former comprises a planetary gear 11, which is retained on a planetary gear carrier 13 so as to be rotatable about its on axis of rotation 12. The planetary gear carrier 13 is in operative engagement with the output member 6, in particular the planet carrier 6, of the summation gearing. In the power steering assembly 1 illustrated in FIG. 1, the planet carrier 6 of the summation gearing has a external toothing for this purpose, which is in rotational engagement with an external toothing of the planetary gear carrier 13 of the epicyclic gearing. Furthermore, the planetary gear carrier 13 is rotatably mounted about a planetary axis 14, which is a planetary axis fixed with respect to the frame with regard to the power steering assembly 1. Thus, the planetary gear 11 is able to rotate both about its own axis of rotation 12 as well as about the planetary axis 14. As is apparent from FIG. 1, the epicyclic gearing in the illustrated exemplary embodiment of the power steering assembly 1 is concentrically disposed around the output shaft 2 and the control member 3.

As is further apparent from FIG. 1, the planetary gear 11, which is configured as a cogwheel in the illustrated power steering assembly 1, is further in operative engagement, in particular in rotational engagement, with one sun gear 15 and one sun gear 16, respectively. The sun gear 15 is non-rotatably connected to the control member 3. The sun gear 16 is non-rotatably connected to the output shaft 2. The two sun gears 15 and 16 have a different number of teeth, so that a rotation of the planetary gear 11 common to both sun gears 15 and 16 about its own axis of rotation 12 results in a relative rotation of the output shaft 2 relative to the control member 3. A rotation of the planetary gear 11 is caused by a rotation of the planetary gear carrier 13 about the planetary axis 14. This rotation can be caused through the drive by the summation gearing. Accordingly, it is possible, by means of a rotation of the planetary gear 11 about its own axis of rotation 12, i.e. in the case of a relative rotation of the planetary gear carrier 13 with respect to the output shaft 2, in which the planetary gear 11 rolls on the sun gears 15 and 16, to adjust a difference angle between the output shaft 2 and the control member 3 in order thus to alter the steering assistance characteristics.

If no difference angle between the two sun gears 15 and 16 is to be adjusted, it is necessary to rotate the planetary gear carrier 13 about the planetary axis 14 with the same angular velocity with which the output shaft 2 rotates. In this case, the planetary gear 11 itself cannot rotate about its own axis of rotation 12.

In the exemplary embodiment of the power steering assembly 1 according to the invention shown in FIG. 1, the planetary gear carrier 13 is rotated by rotating the planet carrier 6.

In the case in which the output element 8 of the actuator 9 or the output shaft 9 of the drive motor 9 stands still but the output shaft 2 rotates, the summation gearing is driven by means of the secondary drive wheel 10 connected to the control member 3. In this case, the gear ratio of the summation gearing is chosen such that the rotation of the first drive member 4 or of the ring gear 4 causes an angular velocity of the output member 6 or of the planet carrier 6 in such a way that the planetary gear carrier 13, due to it being coupled to the planet carrier 6 of the summation gearing, rotates with the same angular velocity as the output shaft 2. Thus, the planetary gear 11 does not rotate about its own axis of rotation 12, so that no difference angle between the sun gears 15 and 16 is generated.

In the case where the output shaft 2 stands still but the output element 9 of the actuator 9 or the output shaft 9 of the drive motor 9 rotates, a rotation of the output member 6 or of the planet carrier 6 is initiated through the rotation of the first drive member 5 or of the sun gear 5 of the summation gearing. Since in that case, the output shaft 2 stands still and the planetary gear carrier 13 is rotated about the planetary axis 14 due to it being coupled to the planet carrier 6, and the planetary gear 11 now rolls on both sun gears 15 and 16, a difference angle is generated between the sun gears 15 and 16, and thus between the output shaft 2 and the control member 3.

The case where both the output shaft 2 and the output shaft 8 of the drive motor 9 rotate, results in a superposition of the two previously described cases, due to the function of the summation gearing of superposing a rotation of the first drive member 4 or of the ring gear 4 with a rotation of the second drive member 5 or of the sun gear 5.

An essential advantage of the power steering assembly 1 described herein over the prior art is that, in order to obtain a clearance-free or almost clearance-free transmission of the gear ratio between the two sun gears 15 and 16, only the planetary gear 11 and the two sun gears 15 and 16 must be designed with a high toothing quality. The eccentrically mounted summation gearing can be configured with toothing parts of a lower quality because the clearances produced there have only a marginal effect on the gear ratio between the control member 3 and the output shaft 2.

Another advantage is that the clearance between the sun gears 15 and 16 and the planetary gear 11 can be reduced by bringing the planetary gear 11 close up to the sun gears 15 and 16.

If the eccentric summation gearing is used, the required construction space of the power steering assembly can also be reduced and the packaging can be optimized.

The power steering assembly according to the invention was explained in more detail with reference to an exemplary embodiment illustrated in the FIGURE. However, the power steering assembly is not limited to the embodiment described herein, but also includes embodiments having the same effects.

In a preferred embodiment, the power steering assembly according to the invention is used for a hydraulic power steering system with a steering torque superposition in a motor vehicle.

### LIST OF REFERENCE NUMERALS

1 Power steering assembly
2 Output shaft
3 Control member
4 First drive member, ring gear
5 Second drive member, sun gear
6 Output member, planet carrier
7 Planet gear
8 Output element, output shaft
9 Actuator, electric drive motor
10 Secondary drive gear
11 Planetary gear
12 Own axis of rotation of 11
13 Planetary gear carrier
14 Planetary axis
15 Sun gear
16 Sun gear

1. A power steering assembly for a hydraulic power steering system of motor vehicles, comprising at least one hydraulic servo valve with a control member (3) for controlling the steering assistance in accordance with a relative rotation of an input shaft with respect to an output shaft (2), and at least one actuator (9) for the relative adjustment of the control member (3) with respect to the input shaft or output shaft (2) in order to influence the steering assistance characteristic,
characterized by
a summation gearing having a first rotatable drive member (4) that is in operative engagement with the control member (3), and a second rotatable drive member (5) that is in operative engagement with an output element (8) of the actuator (9), and an output member (6), wherein the summation gearing superposes a rotation of the first drive member (4) with a rotation of the second drive member (5) and drives, via the output member (6), an epicyclic gearing with at least one planetary gear (11), which is in operative engagement together with both the input shaft or output shaft (2) and with the control member (3) and can be rotated both about a planetary axis (14) fixed with respect to the frame and about its own axis of rotation (12) orbiting about the planetary axis (14), in such a way that a rotation of the first drive member (4) causes a rotation of the own axis of rotation (12) of the planetary gear (11) orbiting about the planetary axis (14) in such a way that no rotation of the planetary gear (11) about its own axis of rotation (12) occurs as a consequence, but a rotation of the second drive member (5) causes a rotation of the planetary gear (11) about its own axis of rotation (12), wherein the rotation of the planetary gear (11) about its own axis of rotation (12) causes a relative rotation of the input shaft or output shaft (2) with respect to the control member (3).

2. The power steering assembly according to claim 1,
characterized in that
the epicyclic gearing is concentrically disposed around the input shaft or output shaft (2) and the control member (3) and has a first sun gear (15) non-rotatably connected to the control member (3) and has a second sun gear (16) non-rotatably connected to the input shaft or output shaft (2), wherein the planetary gear (11) is in rotational engagement with the two sun gears (15, 16).

3. The power steering assembly according to claim 1,
characterized in that
the planetary gear (11) is a cogwheel and the two sun gears (15, 16) of the epicyclic gearing have different external toothings.

4. The power steering assembly according to claim 1,
characterized in that
the at least one planetary gear (11) of the epicyclic gearing is rotatably retained by a planetary gear carrier (13) which is rotatable about the planetary axis (14) of the epicyclic gearing and is in rotational engagement with the output member (6) of the summation gearing.

5. The power steering assembly according to claim 1,
characterized in that
a secondary drive gear (10), which is in rotational engagement with the first drive member (4) of the summation gearing, is non-rotatably connected to the control member (3).

6. The power steering assembly according to claim 1,
characterized in that
the summation gearing is a planetary gearing with a sun gear (5), one or several planet gears (7) rotatably retained by a planet carrier (6) and a ring gear (4), wherein the ring gear (4) forms the first drive member, the sun gear (5) forms the second drive member and the planet carrier (6) forms the output member of the summation gearing.

7. The power steering assembly according to claim 5,
characterized in that
the planetary gearing is a toothed gearing, wherein the ring gear (4) has both an internal toothing, which is in rotational engagement with the one or several planet gears (7), and an external toothing, which is in rotational engagement with a toothing of the secondary drive gear (10).

8. The power steering assembly according to claim 1,
characterized in that
the actuator (9) is an electric drive motor (9) and the output element (8) is an output shaft (8), which is driven by the drive motor (9) and is nonrotatably connected to the second drive member (5) of the summation gearing.

9. The power steering assembly according to claim 1,
characterized in that
the summation gearing is disposed eccentrically with respect to the input shaft or output shaft (2) and the control member (3).

10. The power steering assembly according to claim 6,
characterized in that
the planetary gearing is a toothed gearing, wherein the ring gear (4) has both an internal toothing, which is in rotational engagement with the one or several planet gears (7), and an external toothing, which is in rotational engagement with a toothing of the secondary drive gear (10).
